(19) United States
(12) Patent Application Publication
(10) Pub. No.: US 2012/0147976 A1
(43) Pub. Date: Jun. 14, 2012

(54) Video Transmission On A Serial Interface

(76) Inventor: Gilles Ries, Saint Jean De Molrans (FR)

(21) Appl. No.: 13/265,301

(22) PCT Filed: Apr. 20, 2010
(86) PCT No.: PCT/EP10/55173

§ 371 Date: Feb. 29, 2012

(30) Foreign Application Priority Data
Apr. 20, 2009 (FR) 0952557

(51) Int. Cl. H04N 7/56; H04N 5/06

(52) U.S. Cl. 375/240.28; 348/521; 375/E07.088; 348/E05.011

(57) ABSTRACT

A video transmission circuit for transmitting video data on a digital serial interface to a receive circuit arranged to process the video data at a constant rate, the circuit including a transmission block comprising: a packet generator arranged to generate, for each image of the video data, a plurality of packets, each containing a pixel group of the image; a transmit circuit arranged to transmit the packets of each image on a digital serial interface at time intervals based on the constant rate; and a synchronization circuit arranged to receive from the receive circuit, after transmission of a plurality of packets, a synchronization signal for synchronizing the beginning of the transmission of a next packet.

### BACKGROUND OF THE INVENTION

1. Field of the Invention

The present invention relates to a circuit and a method for transmitting video signals, and in particular to a circuit and a method for transmitting video data on a digital serial interface.

2. Discussion of the Related Art

Portable electronic devices often comprise integrated display panels and/or the capability of providing a video signal to an external display panel such as an LCD (liquid crystal display), plasma, or OLED (organic light-emitting diode) display.

Generally, in such devices, a main processor retrieves video images from a memory. The images can then be directly transmitted from the main processor to an integrated display of the portable device or, if the video signal is to be transmitted to an external display, they may be provided to a video encoder which puts the video images in a format appropriate for external transmission. It is desirable for the internal displays and/or the video encoder to be components separate from the main processor. It has been proposed to provide a serial interface to transmit image data from the main processor to the integrated displays. However, there is a problem in controlling the transmission rate on a serial interface.

An option is to synchronize the video signal transmission rate over the interface with the frame refresh rate of the display. Thereby, the signal can be directly displayed on the screen without any buffering. However, a disadvantage of this solution is that it does not allow the data transmission to be synchronized on a clock different from the one used to synchronize the display. Further, in certain embodiments, it is desirable for two displays to be driven via a hub, while using the same serial interface, which is not possible with this solution.

Alternatively, each video image may form a data packet, transmitted at the maximum bandwidth allowed by the serial interface. A disadvantage of this solution is that it requires a relatively large buffer on the receive side to store the image data before display. Further, if two displays are desired to be driven via a hub while using the same serial interface, there is also a problem in efficiently synchronizing the flow of the two packet streams on their respective display, and a problem of efficiency and flow management between the input and the output of the hub.

### SUMMARY OF THE INVENTION

An object of embodiments of the present invention is to at least partially address one or more disadvantages in the prior art.

According to one aspect of the present invention, there is provided a video transmission circuit for transmitting video data on a digital serial interface to a receive circuit arranged to process the video data at a constant rate, the circuit comprising a transmission block comprising: a packet generator arranged to generate, for each image of the video data, a plurality of packets, each containing a group of pixels of the image; transmission circuitry arranged to transmit the packets of each image over a digital serial interface at time intervals based on the constant rate; and synchronization circuitry arranged to receive from the receive circuit, after transmission of a plurality of packets, a synchronization signal for synchronizing the start of transmission of a next packet.

According to one embodiment, the video transmission circuit comprises a first timing control block arranged to provide a first timing signal to said transmission circuitry, said time intervals being determined based on the first timing signal, and wherein said receive circuitry comprises a second timing control block arranged to provide a second timing signal for controlling the timing of the video processing, the synchronization signal being generated based on the second timing signal.

According to another embodiment, each group of pixels is a line of an image, and the packet generator is arranged to generate packets, each of which comprises N lines of pixels, and wherein the transmission circuitry is arranged to transmit the packets of each image over the digital serial interface at time intervals selected to correspond to N line periods, wherein N is an integer between 1 and M/2, M being the number of lines of each image.

According to another embodiment, the video transmission circuit further comprises a digital serial interface coupled to the transmission circuitry, and receive circuitry coupled to the digital serial interface for receiving said packets, the receive circuitry comprising a pixel buffer for temporarily storing said packets.

According to another embodiment, the pixel buffer has a capacity smaller than or equal to an image of the video data.

According to another embodiment, the receive circuitry comprises a video encoder.

According to another embodiment, the receive circuitry comprises a hub coupled to a plurality of displays, the video transmission circuitry being arranged to transmit video data to each of the displays, and further comprising an additional packet generator and additional transmission circuitry associated with each display.

According to another embodiment, the synchronization circuitry is arranged to transmit a synchronization request to the receive circuitry after transmission of a plurality of packets.

According to another embodiment, the synchronization signal is a vertical synchronization signal for synchronizing the processing of the frames by the receive circuitry.

According to another aspect of the present invention, there is provided an electronic device comprising a memory arranged to store video data coupled to the above video transmission circuit.

According to another aspect of the present invention, there is provided a method for transmitting video data over a digital serial interface to receive circuitry, the receive circuitry being arranged to process the video data at a constant rate, the method comprising: generating by a packet generator, for each image of the video data, a plurality of packets, each of which contains a group of pixels of the image; transmitting by transmission circuitry the packets of each image on a digital serial interface at time intervals based on said constant rate; and receiving from the receive circuitry, after transmission of a plurality of packets, a synchronization signal for synchronizing the start of transmission of a next packet.

According to another embodiment, the start of transmission of the next packet is controlled to be equal to a configurable time delay after the transmission of the previous packet.

According to another embodiment, the method further comprises the storage by the receive circuitry of the received image data of said packets in a pixel buffer.

According to another embodiment, the method further comprises providing a first timing signal for synchronizing said time intervals and a second timing signal for controlling the timing of the video processing, the first timing signal being generated based on the second timing signal.

According to another embodiment, the method further comprises requesting said synchronization signal after transmission of each plurality of packets, and pausing the packet transmission until said synchronization signal is received.

In an embodiment, a video transmission circuit comprises: a packet generator configured to generate, for each image of video data to be transmitted, a plurality of packets, each packet containing a pixel group of the image; a transmitter configured to transmit a number of packets of the plurality of packets on a digital serial interface at time intervals based on a constant rate associated with a processing rate of a receive circuit, wherein the number of packets is more than one packet; and a synchronizer configured to receive, after transmission of the number of packets of the plurality of packets, a synchronization signal for synchronizing a beginning of a transmission of a next packet.

In an embodiment, the video transmission circuit comprises a first synchronization control block configured to deliver a first synchronization signal to the transmitter, said time intervals being determined according to the first synchronization signal, and the receive circuit comprises a second synchronization control block configured to deliver a second synchronization signal for controlling the synchronization of video processing, the synchronization signal received by the synchronizer being generated based on the second synchronization signal.

In an embodiment, each group of pixels is a line of the image, and the packet generator is arranged to generate packets, each of which comprises a pixel line, and where the transmit circuit is arranged to transmit the packets of each image on the digital serial interface at intervals selected to correspond to N line durations, N being an integer ranging between 1 and M/2 and M being a number of lines of each image.

In an embodiment, the video transmission circuit further comprises a digital serial interface coupled to the transmit circuit, and a receive circuit coupled to the digital serial interface to receive the packets, the receive circuit comprising a pixel buffer for temporarily storing the packets.

In an embodiment, the pixel buffer has a capacity smaller than or equal to an image of the video data.

In an embodiment, the receive circuit comprises a video encoder.

In an embodiment, the receive circuit comprises a dispatcher coupled to a plurality of displays, the video transmission circuit being configured to transmit video data to each of the displays, and further comprising a generator of additional packets and a transmitter associated with each display.

In an embodiment, the synchronizer is configured to transmit a synchronization request after transmission of the number of packets in the plurality of packets. In an embodiment, the synchronization signal is a vertical synchronization signal for synchronizing the processing of frames by a receive circuit. In an embodiment, the packet generator is configured to generate for each image in an image stream, more than one set of a plurality of packets. In an embodiment, the number of packets of the plurality of packets is a subset of the plurality of packets.

In an embodiment, an electronic device comprises: a memory storing video image data; a packet generator coupled to the memory and configured to generate, for each image of video data to be transmitted, a plurality of packets, each packet containing a pixel group of the image; a transmitter configured to transmit packets in the plurality of packets on a digital serial interface at time intervals based on a constant rate associated with a receiver; and a synchronizer configured to receive, after transmission of a number of packets of the plurality of packets, a synchronization signal for synchronizing a beginning of a transmission of a next packet, wherein the number of packets of the plurality of packets is more than one packet.

In an embodiment, the synchronizer is a first synchronizer configured to deliver a first synchronization signal to the transmitter, the time intervals being determined according to the first synchronization signal, the device further comprising: a receiving block including a second synchronizer configured to deliver a second synchronization signal for controlling the synchronization of the video processing, the synchronization signal received by the first synchronizer being generated based on the second synchronization signal.

In an embodiment, each group of pixels is a line of the image; the packet generator is arranged to generate packets, each of which comprises a pixel line; and the transmitter is arranged to transmit the packets of each image on the digital serial interface at intervals selected to correspond to N line durations, N being an integer ranging between 1 and M/2 and M being a number of lines of each image.

In an embodiment, the electronic device further comprises a digital serial interface coupled to the transmitter, and a receiver coupled to the digital serial interface to receive the packets, the receiver comprising a pixel buffer for temporarily storing the packets.

In an embodiment, the pixel buffer has a capacity smaller than or equal to an image of the video data.

In an embodiment, the receiver comprises a video encoder.

In an embodiment, the receiver comprises a dispatcher coupled to a plurality of displays, the transmitter being arranged to transmit video data to each of the displays, the electronic device comprising a packet generator and a transmitter associated with each display.

In an embodiment, the synchronizer is arranged to transmit a synchronization request to the receiver after transmission of the number of packets.

In an embodiment, the synchronization signal is a vertical synchronization signal for synchronizing the processing of frames by the receiver.

In an embodiment, the packet generator is configured to generate for each image in an image stream, more than one set of a plurality of packets.

In an embodiment, the number of packets is a subset of the plurality of packets.

In an embodiment, a method comprises: generating, for each image of video data to be transmitted to a receiver through a digital serial interface, a plurality of packets, each packet comprising a pixel group of the image; transmitting a number of packets of the plurality of packets of each image on a digital serial interface at determined time intervals based on a constant associated with a video processing rate of the receiver, wherein the number of packets is more than one packet; and receiving from the receiver, after transmission of the number of packets of the plurality of packets, a synchronization signal for synchronizing a beginning of a transmission of a next packet.

In an embodiment, the beginning of the transmission of the next packet is controlled to be equal to a delay configurable after the transmission of a previous packet. In an embodiment, the method further comprises storage by the receiver of the image data received in said packets into a pixel buffer.

In an embodiment, the method further comprises generating a first synchronization signal for synchronizing said time intervals and a second synchronization signal for controlling the synchronization of video processing, the synchronization signal being generated as a function of the second synchronization signal.

In an embodiment, the method further comprises requesting the synchronization signal after transmission of each number of the plurality of packets, and of interrupting packet transmission until the synchronization signal has been received.

In an embodiment, a computer readable memory medium's contents cause an electronic device to perform a method, the method comprising: generating, for each image of video data to be transmitted to a receiver through a digital serial interface, a plurality of packets, each packet comprising a pixel group of the image; transmitting a number of the plurality of packets of each image on a digital serial interface at time intervals based on a constant associated with a video processing rate of the receiver, the number of packets being more than one packet; receiving from the receiver, after transmission of the number of packets of the plurality of packets, a synchronization signal; and synchronizing a transmission of a next packet based on the synchronization signal.

In an embodiment, the number of packets is a subset of the plurality of packets.

In an embodiment, an electronic device comprises: means for generating, for each image of video data to be transmitted, a plurality of packets, each packet comprising a pixel group of the image; means for transmitting a number of the plurality of packets of each image on a digital serial interface at time intervals based on a constant associated with a video reception processing rate, the number of packets being more than one packet; and means for synchronizing transmission of a next packet after the number of packets have been transmitted based on a synchronization signal.

In an embodiment, the electronic device further comprises: means for receiving the generated packets; and means for carrying the packets as serial digital signals coupled between the means for transmitting and the means for receiving.

In an embodiment, the means for receiving comprises a pixel buffer for temporarily storing the packets, the pixel buffer having a capacity smaller than or equal to an image of the video data.

In an embodiment, the means for receiving comprises a dispatcher coupled to a plurality of displays; the means for generating comprises a plurality of packet generators each configured to generate packets associated with a corresponding display in the plurality of displays; and the means for transmitting comprises a plurality of transmitters, each configured to transmit packets associated with a corresponding display in the plurality of displays.

The foregoing objects, features, and advantages of the present invention will be discussed in detail in the following non-limiting description of specific embodiments in connection with the accompanying drawings.

### BRIEF DESCRIPTION OF THE DRAWINGS

FIG. 1 shows a portable device according to an embodiment of the present invention;

FIG. 2 shows in further detail the portable device of FIG. 1 according to an embodiment of the present invention;

FIG. 3 shows a timing diagram of a video frame according to embodiments of the present invention;

FIG. 4 is a timing diagram showing the synchronization of the video transmission on a digital serial interface according to an embodiment of the present invention;

FIG. 5 shows the portable electronic device of FIG. 1 in more detail according to an alternative embodiment of the present invention; and

FIG. 6 is a timing diagram illustrating the timing of the video transmission on a digital serial interface such as that of FIG. 5 according to an embodiment of the present invention.

### DETAILED DESCRIPTION

In the drawings, the same features have been designated with the same reference numerals.

FIG. 1 shows a portable electronics device 102, which is for example, a cell phone, a smartphone, a laptop computer, a portable game console, or another electronics device. Device 102 comprises a multimedia chip 104 (MM CHIP), which is for example the processing platform of the portable device. Chip 104 is coupled to a memory 105 (MEM) of the device, from which data to be displayed on one or more integrated or external displays can be retrieved. For example, device 102 comprises one or more integrated displays 106 (SPA), 108 (SPB), and/or may be connected to an external display panel 110 (P EXT).

The video data is provided by chip 104 to a receive circuit 111, which comprises one or both of displays 106, 108 coupled to a serial interface hub 112 and/or an encoding circuit 114, for formatting the video signal so that it is suitable for an external transmission to display 110.

The interface between chip 104 and receive circuit 111 is a digital serial interface (DSI) 114 comprising a DSI transmit block 115 (DSI TX) on the chip side, a DSI receive block 116 (DSI RX) on the receive side and, for example, one or more data lanes 118 and at least one clock lane 120 coupled between blocks 115 and 116.

Two data lanes 118 for example provide up to twice the data rate of a single serial data lane. Each data lane 118 for example comprises a single wire or a pair of differential wires to provide some noise compensation. Such a serial interface comprising more than one wire is not the same as a parallel interface. In a parallel interface, the bits of a symbol, for example, 8 or 12 data bits, are transmitted at the same time over 8 or 12 separate wires, while in a serial interface, the data bits forming each data symbol are transmitted in series, one after the other over a same lane. For example, in a serial interface, a first byte is sent on the first data lane, a second byte is sent on the second data lane, and then a third byte is sent on the first data lane, and so on. However, the same byte is not distributed on many data lanes. Thus, while a parallel connection suffers problems due to propagation time differences between the parallel lanes, and thus transmission speeds and distances are limited, serial interfaces, even comprising several data lanes, do not have such disadvantages.

Clock lane 120 is for example used to transmit a clock signal DSI_CLK comprising timing information enabling the serial data signal to be properly received at the DSI receive block 116.

DSI interface 114 for example complies with the MIPI standard (mobile industry processor interface) which is a display serial interface protocol intended to be used when video data is transferred between an image processor and an LCD integrated in a portable device. The DSI standard is not intended to be used to provide video data to a video encoder for display on an external display. However, according to embodiments described herein, the DSI interface is adapted to such a use. Furthermore, the same serial interface 114 as that described herein is used to provide data to one or more of the integrated displays and/or to the external display. In alternative embodiments, the DSI interface 114 may be replaced with any appropriate serial interface.

The DSI interface allows a video mode and a command mode of operation. In the video mode, a synchronous operation is provided between the data transmission over the serial link and internal displays. In the command mode of operation, an integrated display of the device may be controlled by asynchronous data commands. The embodiments described herein for example use the command mode of the DSI standard, but allow a virtually synchronous operation, as will be described hereafter.

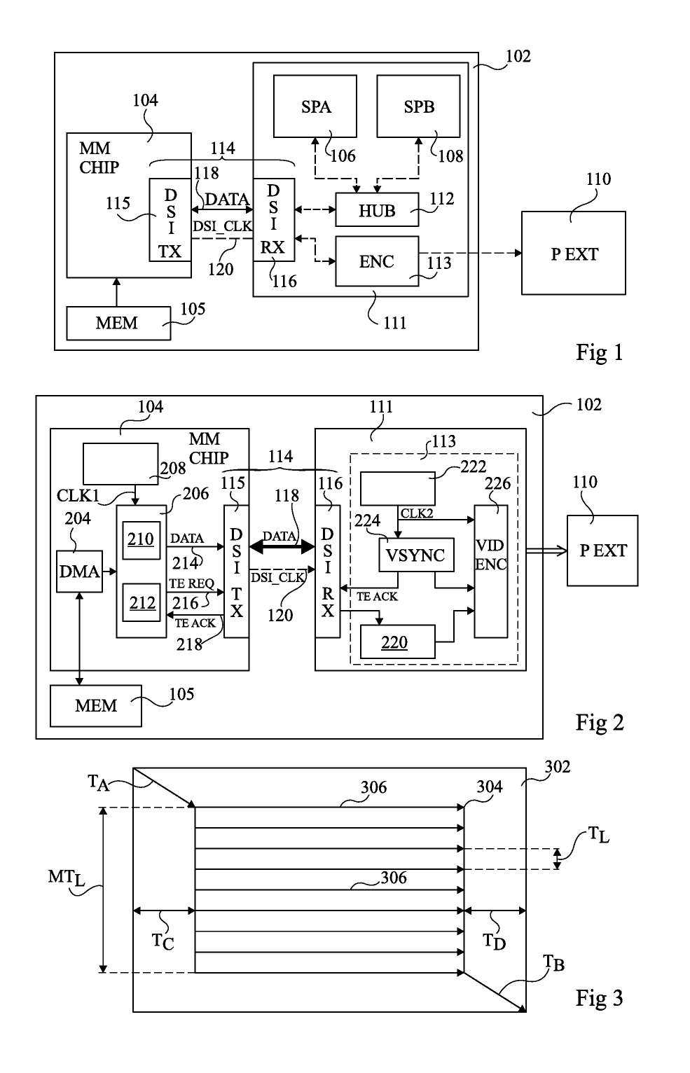

FIG. 2 shows in further detail portable device 102 according to an example where receive circuit 111 comprises an encoder circuit 113 for providing a signal to external display 110.

Memory 105 is accessed by multimedia chip 104 via a DMA (direct memory access) block 204, which provides the video data to a processing block 206. Block 206 also receives a clock signal CLK1 from a timing control block 208 and comprises a packet generator 210 and a packet transmission circuit 212. Packet generator 210 receives image data from DMA 204 and divides each image into a plurality of packets. These packets are then provided by packet transmission circuit 212 via a data line 214 to DSI transmit block 115 for transmission over DSI interface 114. Block 206 is also coupled to the DSI transmit block by lines 216 and 218 to transmit and receive tearing effect request and acknowledgement signals, respectively.

Encoding circuit 113 comprises a pixel buffer 220 for receiving the image data packets transmitted over the DSI interface 114. A synchronization control block 222 provides a clock signal CLK2 to a vertical synchronization block 224 (VSYNC), which is coupled to DSI receive block 116 to provide an acknowledgement signal TE, and to a video encoder 226, to provide a vertical synchronization signal. The video encoder also receives a signal CLK2, which is for example a pixel clock. Video encoder 226 is coupled to receive image data from pixel buffer 220 and has an output coupled to external display panel 110.

The transmission of each packet over DSI interface 114 may be performed at a rate similar (to within a small tolerance) to that of the data processed by video encoder 226 and displayed on display 110, to reduce any possibility of buffer underflow or overflow. At the same time, the image data packets are transmitted at time intervals which correspond to the timing of the image data when displayed.

In operation, when a video signal is desired to be displayed on external display 110, chip 104 controls DMA unit 204 to retrieve the corresponding video data from memory 105. The image data is provided to packet generator 210, which divides each image of the video data into a plurality of packets. Each packet for example comprises one line of an image. Assuming that each image of the video signal has M lines, each image is thus divided into M packets. Alternatively, each packet comprises N lines, where N is in the range one to M/2, so that each image is divided into at least two packets. In certain cases, the packets may be of variable sizes. As an example, if the packets generally contain N lines, but M is not divisible by N to provide an integer result, the last packet may for example comprise less than N lines, according to what is needed to complete the current image.

The image data packets generated by generator 210 are provided by a packet transmission circuit 212 to DSI transmit block 115 for a transmission on DSI interface 114 at determined time intervals, the timing being based on clock CLK1. DSI transmit block 115 transmits each packet serially on the data lanes 118, at the same time as the DSI_CLK clock signal used to control timing over the serial interface.

DSI receive block 116 receives the packets and stores the extracted image data in a pixel buffer 220. The image data is then provided to video encoder 226, which formats this data to have it correspond, for example, to one or more determined formats, and provides the video signal at an output terminal connected to external display 110. This formatting operation may for example be performed to provide analog video signals of type PAL, SECAM, or NTSC on a composite video connection, such as a Chroma Video Blanking Synchro (CVBS) connection, or an RGB connection, an S-Video connection and/or a SCART connection, etc. Alternatively, a digital video signal could be provided of the type DVB, ATSC, or ISDB (Integrated Service digital broadcasting (Japan)), connected via a digital interface such as an HDMI, DVI, etc. The vertical synchronization signal originating from block 224 comprises time data corresponding to the display rate of the images and the video encoder provides the video signal to the external display at this rate.

Once a certain number of packets have been transmitted over the DSI interface 114, processing circuit 206 provides a tearing effect request TE REQ on line 216 to transmit block 115 and waits for a response TE ACK on a line 218 before the packet transmission is resumed. This protocol is used to prevent a buffer overflow as will now be described.

Data lanes 118 of DSI interface 114 allow data rates higher than the rate at which the image data is displayed. Furthermore, the same data lanes 118 are for example used to transmit packets to one or more integrated displays (not shown in FIG. 2) at the same time as to the external display 110, in which case the data rate on DSI interface 114 may be considerably greater than the display rate of the image data on any one of the displays. Pixel buffer 220 is used to temporarily store the received image data at this higher rate before they are processed by the video encoder. The size of buffer 220 is for example relatively small, and for example corresponds to just a few lines of image data, such as between 2 and 5 lines.

A buffer overflow should generally be avoided, since it results in a degradation of the image displayed on the external display, as the image data stored in buffer pixel 220 may be overwritten by new data before being read by video encoder 226.

In the embodiments described herein, each packet of an image may be transmitted at time intervals based on the rate at which the image data will be processed. The packet transmission timing is based on clock CLK1 in chip 104, while the rate at which the image data is processed is based on pixel clock CLK2 of receive circuit 111. Packet transmission circuit 212 determines, for example, based on clock CLK1 and on its knowledge of the image processing, the time intervals to be provided between each packet.

Clocks CLK1 and CLK2 are for example selected to be as synchronous as possible with respect to each other. In other words, they are for example substantially at the same frequency or at frequencies that differ from each other by a substantially fixed ratio. However, since they originate from different sources, clocks CLK1 and CLK2 are likely to be slightly desynchronized. Clock signals CLK1 and CLK2 are for example generated with a ±0.1 percent tolerance, which implies a variation of ±1 cycle every 1000 cycles.

To avoid the risk of underflow, the frequencies of signals CLK1 and CLK2 are for example selected so that, assuming a maximum variation of these signals, the image data are not transmitted slower than the display rate.

To avoid an overflow of the image data in pixel buffer 220, the TE REQ and TE ACK protocol is used over the serial interface to allow the transmission of image data on the serial interface to periodically stop and resynchronize with the video encoder.

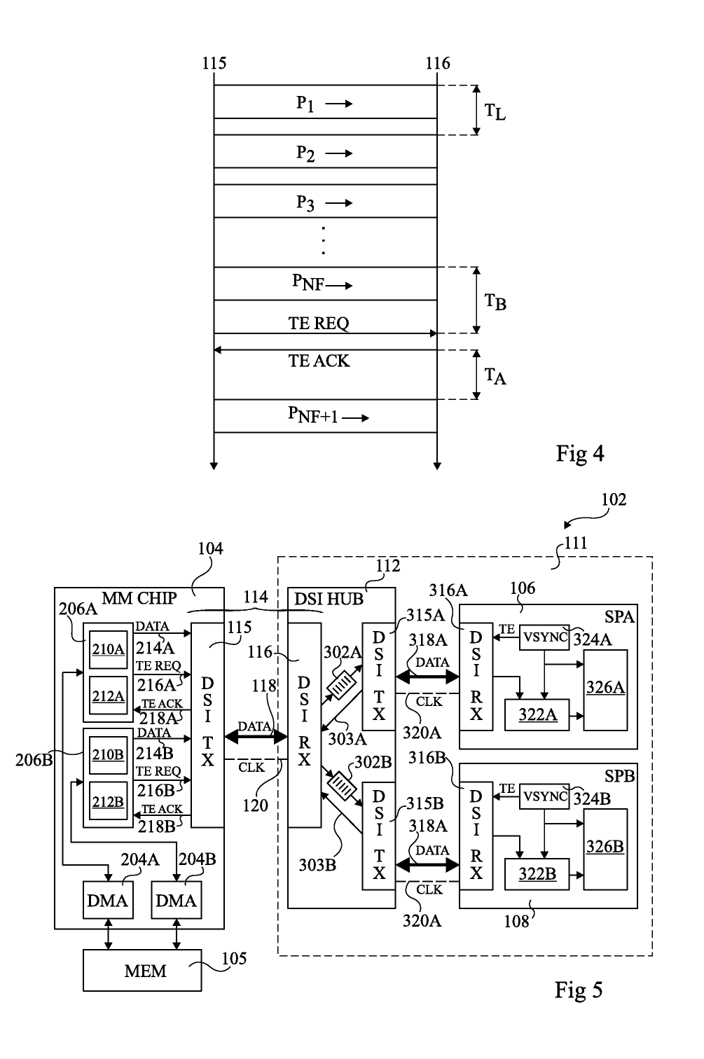

An example of the timing of the video transmission in the circuit of FIG. 2 will now be described, referring to the diagrams of FIGS. 3 and 4.

FIG. 3 shows an image frame 302, comprising an active image area 304 corresponding to an image for display. Frame 302 illustrates the timing associated with the display of image 304. Image 304 comprises image lines 306, displayed from left to right in this example. Each of the lines comprises a succession of pixels so that an image of M lines, each of which comprises P pixels, has an image area of P by M pixels.

The number M of lines and number P of pixels are for example in the range 2 to several thousand.

In each frame, a line period, labeled T_{L} in FIG. 3, is the time period between the start of a line and the start of the next line. Blank time periods T_{A} and T_{B} are generally provided, each of which corresponds to one or more line periods T_{L}. Period T_{A} is after the start of each frame and before the start of the image, and period T_{B} is after each image and before the start of the next frame. Generally, in each line, short time periods T_{C} and T_{D} are provided before and after the image portion of each line, respectively. The time period between the start of the first image data line and the end of the last image data line of a frame corresponds to MT_{L}, M being the number of lines in the image.

FIG. 4 shows an example of the packets and data transmitted on DSI interface 114 between DSI transmit block 115 and DSI receive block 116. Packet generator 210 is assumed to divide each image into M packets, each packet corresponding to one line of the image in this example.

When a video signal originating from memory 105 is to be displayed, after an optional configuration of the video decoder for a new video signal, a first packet P₁ containing the pixel data of the first line of the first image is first transmitted on DSI interface 114.

A certain time delay T_{L} after the start of the transmission of the first packet P₁, determined by CLK1, a second packet P₂ is transmitted over the interface, followed by a third packet P₃ after another delay T_{L}, etc., until the last packet P_{NF} containing the last line of the first image is transmitted.

A certain time delay, for example equal to T_{B} of FIG. 3, after the start of the transmission of the last packet P_{NF}, a tearing effect request signal TE REQ is transmitted from block 115 to block 116, requesting a synchronization signal. DSI transmit block 115 then waits for an acknowledgement signal TE ACK. The VSYNC block 224 of receive circuit 111 responds by transmitting a synchronization signal TE ACK from block 116 to block 115 when the end of the frame has been reached.

A certain time delay, for example equal to T_{A} of FIG. 3, after the reception of signal TE ACK, a first packet P_{NF+1} of the next frame is transmitted on DSI interface 114.

FIG. 5 shows an alternative embodiment of the portable device 102 in which receive circuit 111 comprises a DSI hub 112 and the same DSI data lanes 118 of DSI interface 114 are used for providing video data to a plurality of displays, in this example integrated display panels SPA 106 and SPB 108.

Multimedia chip 104 accesses memory 105 via a pair of DMA units 204A and 204B to receive video data for transmission to respective display panels SPA 106 and SPB 108. Each of the DMA units is then coupled to respective processing blocks 206A and 206B, each of which comprises a packet generator 210A, 210B and a packet transmission circuit 212A, 212B. These blocks perform the same functions as the corresponding blocks of FIG. 2 except that, given that there is a single DSI interface, the packet transmission by blocks 212A and 212B does not occur simultaneously, and for example occurs in alternated fashion.

Blocks 206A and 206B are coupled to DSI transmit block 115 by data lines 214A, 214B for providing image data packets, and lines 216A, 216B and lines 218A, 218B for transmitting and receiving TE request and acknowledgment signals, respectively.

DSI hub 111 comprises buffers 302A, 302B which are, for example, first-in-first-out (FIFO) type buffers coupled to receive image data from DSI receive block 116, intended for panels SPA 106 and SPB 108, respectively. For example, each packet received by DSI receive block 116 comprises a header indicating the destination display, such that the image data that it contains is routed to the correct buffer 302A, 302B.

Buffers 302A, 302B are coupled to respective DSI interfaces between hub 111 and each of displays 106 and 108. In particular, the DSI interface with display 106 comprises a DSI transmit block 315A, a DSI receive block 316A, a DSI data lane 318A, and a DSI clock lane 320A, while the DSI interface with display 108 comprises a DSI transmit block 315B, a DSI receive block 316B, a DSI data lane 318B, and a DSI clock lane 320B.

Displays 106 and 108 are smart panels comprising LCD, OLED, plasma panels or other types of display panels, and circuits for receiving the image data packets received over the DSI interface and for displaying the video data.

Display 106 comprises a pixel buffer 322A coupled to receive the image data from DSI receive block 316, a timing control block VSYNC 324A, which synchronizes the display of the image, and a display panel 326A, which displays the image data stored in pixel buffer 322A. Display 108 comprises the same components as display 106, which are labeled with suffix “B”.

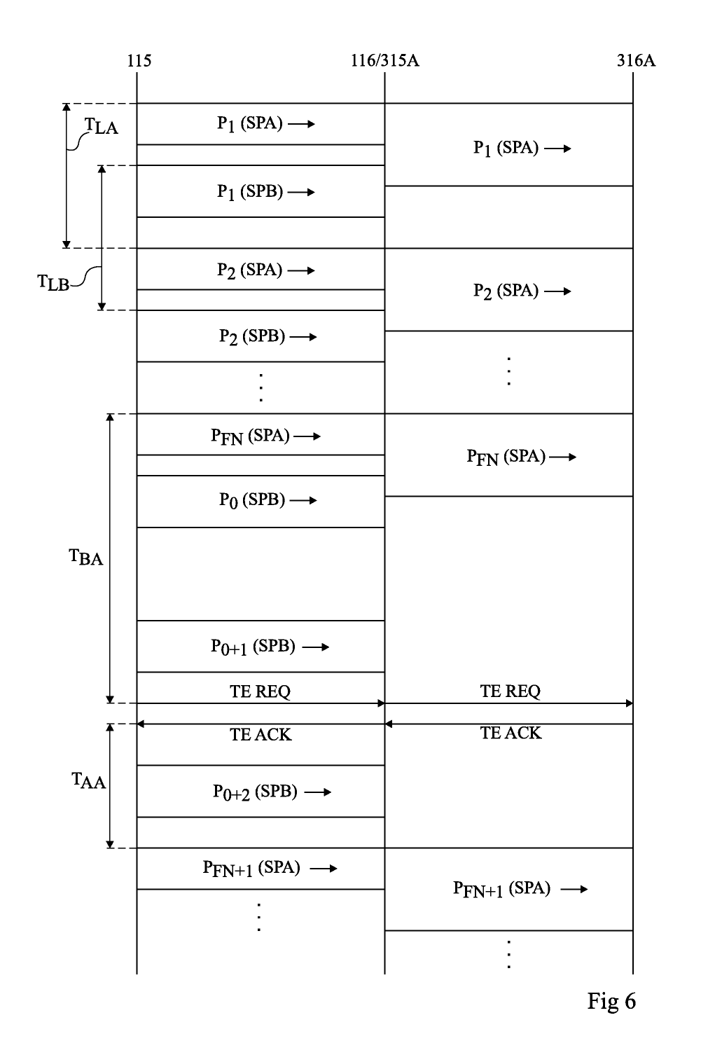

The operation of the circuit of FIG. 5 will now be described in relation with the timing diagram of FIG. 6.

FIG. 6 shows an example of data transfer between DSI transmit block 115 and DSI receive block 116, and between DSI transmit block 315A and DSI receive block 316A.

Main DSI interface 114 to the DSI hub is used to transmit image data to the two displays 106 and 108. In this example, initially, a first packet P₁ (SPA) intended for display 106 is transmitted over data lanes 118. This packet is received by DSI receive block 116 and transmitted to DSI transmit block 315A to display 106, shortly thereafter. As shown, given that the transmission over DSI interface 114 is very fast, for example because there are a plurality of data lanes 118, the transmission to display 106 is slower, for example because there is a single data lane 318A.

Next, a first packet P₁ (SPB) intended for display 108 is transmitted over data lanes 118. Although this has not been shown in FIG. 6, this packet is then transmitted from DSI transmission block 315B to display 108.

A time delay T_{LA} after the start of the transmission of first packet P₁ (SPA), second packet P₂ (SPA) intended for display 106 is transmitted on DSI interface 114. T_{LA} for example corresponds to the line period associated with display 106. Again, this is then transmitted via the data connection of DSI transmit block 315A to DSI receive block 316A. Line durations T_{LA} and T_{LB} are different in this example, T_{LA} being shorter than T_{LB}. However, these durations may be identical, or T_{LA} may be longer than T_{LB}.

A time delay T_{LB} after the start of the transmission of the first packet P₁ (SPB), second packet P₂ (SPB) intended for display 108 is transmitted over DSI interface 114. T_{LB} for example corresponds to the line period associated with display 108.

The alternated transmission of the packets, alternately to displays 106 and 108, for example continues until the last packet P_{FN} (SPA) of the first image is transmitted over data lanes 118. The packet transmission to display 106 then momentarily stops while the transmission to display 108 continues with the transmission of further packets P₀ (SPB) and P₀₊₁ (SPB).

A time delay T_{BA} after the start of the transmission of packet P_{FN} (SPA), a TE request signal is transmitted from DSI transmit block 115 to DSI receive block 316A. T_{BA} for example corresponds to the time period T_{B} of FIG. 3 associated with display 106.

It should be noted that displays 106 and 108 have pixel clocks CLK2A and CLK2B, which may drift slightly over time, which will offset the ideal position of the transmission of the packets intended for each display with respect to each other. However, even if it is determined that two packets are ideally transmitted at the same time, there generally exists a tolerance in the system, enabling packets to be slightly delayed with respect to their ideal transmission time. One of the packets can thus wait for some time before being sent, until the ongoing packet transmission is over.

Display 106 responds to request TE by transmitting a TE acknowledgement signal over data lane 318A at the end of the frame. This signal is transmitted over an acknowledgement line 303A from DSI transmit block 315A to DSI receive block 116 and then on DSI interface 114 to DSI transmit block 115, from which it is sent to processing block 206A via TE acknowledgement line 218A. A further packet P₀₊₂ (SPB) is then transmitted to display 108.

A time delay T_{AA} after the reception of the TE acknowledgement signal, a first packet P_{FN+1} (SPA) of the image data for the next frame intended for display 106 is transmitted on DSI interface 114. The transmission continues in this way.

An advantage of the transmission of image data packets over the serial interface at determined time intervals based on the rate at which they will be displayed is that a plurality of packets may be transmitted before a resynchronization is performed and the pixel buffer on the receive side may be relatively small.

Furthermore, an advantage of providing packets to a plurality of displays on a same serial interface to a hub, over which the image data packets for each display are transmitted at determined time periods, is that this makes efficient use of the bandwidth of the serial interface.

Furthermore, an advantage of the sending of synchronization signal TE ACK only once a plurality of packets have been transmitted is that bandwidth of the serial interface is economized with respect to the transmission of synchronization signal TE ACK after the reception of each packet.

Although several specific embodiments have been shown, it should be clear to those skilled in the art that variations are possible.

For example, while in the embodiment of FIG. 2, image data are provided to an external display and in the embodiment of FIG. 5, the image data is provided to two integrated displays, in alternative embodiments, receive circuit 111 of FIG. 5 may further comprise video encoding block 111 of FIG. 2, such that the image data may further be provided to an external display.

Furthermore, while FIG. 6 shows a specific example of a packet transmission sequence, it should be clear to those skilled in the art that, in alternative embodiments, different sequences will be possible, depending on the line periods of each display.

Some embodiments may take the form of or comprise computer program products. For example, according to one embodiment there is provided a computer readable medium comprising a computer program adapted to perform one or more of the methods or functions described above. The medium may be a physical storage medium such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the systems and/or modules and/or circuits and/or blocks may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1-15. (canceled)

16. A video transmission circuit for transmitting video data on a digital serial interface to a receive circuit configured to process the video data at a constant rate, the circuit comprising a transmission block comprising:
a packet generator configured to generate, for each image of the video data, a plurality of packets, each containing a group of pixels of the image;
transmission circuitry configured to transmit the packets of each image over a digital serial interface at time intervals based on the constant rate; and
synchronization circuitry configured to receive from the receive circuit, after transmission of a plurality of packets, a synchronization signal for synchronizing the start of transmission of a next packet.

17. The video transmission circuit of claim 16, comprising a first timing control block configured to provide a first timing signal to said transmission circuitry, said time intervals being determined based on the first timing signal, and wherein said receive circuitry comprises a second timing control block configured to provide a second timing signal for controlling the timing of the video processing, the synchronization signal being generated based on the second timing signal.

18. The video transmission circuit of claim 16, wherein each group of pixels is a line of an image, and the packet generator is configured to generate packets, each of which comprises N lines of pixels, and wherein the transmission circuitry is configured to transmit the packets of each image over the digital serial interface at time intervals selected to correspond to N line periods, wherein N is an integer between 1 and M/2, M being the number of lines of each image.

19. The video transmission circuit of claim 16, further comprising a digital serial interface coupled to the transmission circuitry, and receive circuitry coupled to the digital serial interface for receiving said packets, the receive circuitry comprising a pixel buffer for temporarily storing said packets.

20. The video transmission circuit of claim 19, wherein the pixel buffer has a capacity smaller than or equal to an image of the video data.

21. The video transmission circuit of claim 19, wherein the receive circuitry comprises a video encoder.

22. The video transmission circuit of claim 19, wherein the receive circuitry comprises a hub coupled to a plurality of displays, the video trans-mission circuitry being configured to transmit video data to each of the displays, and further comprising an additional packet generator and additional transmission circuitry associated with each display.

23. The video transmission circuit of claim 16, wherein the synchronization circuitry is configured to transmit a synchronization request to the receive circuitry after transmission of a plurality of packets.

24. The video transmission circuit of claim 16, wherein the synchronization signal is a vertical synchronization signal for synchronizing the processing of the frames by the receive circuitry.

25. An electronic device comprising:
a video transmission circuit and a memory coupled to said video transmission circuit;
said memory configured to store video data; and
said video transmission circuit comprising a transmission block comprising:
a packet generator configured to generate, for each image of the video data, a plurality of packets, each containing a group of pixels of the image;
transmission circuitry configured to transmit the packets of each image over a digital serial interface at time intervals based on the constant rate; and
synchronization circuitry configured to receive from the receive circuit, after transmission of a plurality of packets, a synchronization signal for synchronizing the start of transmission of a next packet.

26. A method for transmitting video data over a digital serial interface to receive circuitry, the receive circuitry being configured to process the video data at a constant rate, the method comprising:
generating by a packet generator, for each image of the video data, a plurality of packets, each of which contains a group of pixels of the image;
transmitting by transmission circuitry the packets of each image on a digital serial interface at time intervals based on said constant rate; and
receiving from the receive circuitry, after transmission of a plurality of packets, a synchronization signal for synchronizing the start of transmission of a next packet.

27. The method of claim 26, wherein the start of transmission of the next packet is controlled to be equal to a configurable time delay after the transmission of the previous packet.

28. The method of claim 26, further comprising the storage by the receive circuitry of the received image data of said packets in a pixel buffer.

29. The method of claim 26, further comprising providing a first timing signal for synchronizing said time intervals and a second timing signal for controlling the timing of the video processing, the first timing signal being generated based on the second timing signal.

30. The method of claim 26, further comprising requesting said synchronization signal after transmission of each plurality of packets, and pausing the packet transmission until said synchronization signal is received.
